(19) United States
(12) Patent Application Publication
(10) Pub. No.: US 2026/0094593 A1
(43) Pub. Date: Apr. 2, 2026

(54) ELECTRONIC MACHINE, DISPLAY METHOD, AND RECORDING MEDIUM

(71) Applicant: Roland Corporation, Shizuoka (JP)

(72) Inventor: Marori Yoshioka, Shizuoka (JP)

(73) Assignee: Roland Corporation, Shizuoka (JP)

(21) Appl. No.: 19/289,121

(22) Filed: Aug. 4, 2025

(30) Foreign Application Priority Data
Aug. 23, 2024 (JP) 2024-141770

(51) Int. Cl. G10H 3/26; G10H 1/32

(52) U.S. Cl. CPC G10H 3/26; G10H 1/32; G10H 2220/026; G10H 2220/161; G10H 2230/301; G10H 2230/321

(57) ABSTRACT

Provided is an electronic machine to which an electronic percussion instrument is connected, the electronic machine including a processor configured to display a striking surface display that models a striking surface of the electronic percussion instrument and is composed of at least a two-dimensional image, and display a strike position display disposed at at least a two-dimensional position based on a strike position acquired from the electronic percussion instrument at a corresponding position on the striking surface display.

### CROSS-REFERENCE TO RELATED APPLICATION

This application claims the priority benefit of Japan application serial no. 2024-141770, filed on Aug. 23, 2024. The entirety of the above-mentioned patent application is hereby incorporated by reference herein and made a part of this specification.

### BACKGROUND

### Technical Field

The disclosure relates to an electronic machine, a display method, and a non-transient computer-readable recording medium, recording a display program.

### Description of Related Art

Patent Literature 1 (Japanese Patent Application Laid-Open Publication No. H10-198353) discloses an electronic percussion instrument device that displays strike position information AP based on strikes to a connected strike detection device. Specifically, as the strike position information AP, the struck position in a uniaxial direction from the center to the rim of the head of the strike detection device is displayed. This allows the user to confirm how far the strike position is from the center of the head when striking the strike detection device.

However, since the displayed strike position information AP is in a uniaxial direction, there is a problem that the user cannot specifically confirm which position of the head was struck.

The disclosure provides an electronic machine, a display method, and a non-transitory computer-readable recording medium, recording a display program that allow a user to specifically grasp the position where an electronic percussion instrument was struck.

### SUMMARY

The electronic machine of the disclosure is connected to an electronic percussion instrument, and includes a processor configured to display a striking surface display that models a striking surface of the electronic percussion instrument and is composed of at least a two-dimensional image, and display a strike position display disposed at at least a two-dimensional position based on a strike position acquired from the electronic percussion instrument at a corresponding position on the striking surface display.

The display method of the disclosure includes displaying a striking surface display that models a striking surface of a connected electronic percussion instrument and is composed of at least a two-dimensional image, and displaying a strike position display disposed at at least a two-dimensional position based on a strike position acquired from the electronic percussion instrument at a corresponding position on the striking surface display.

Further, the non-transitory computer-readable recording medium of the disclosure records a display program for causing a computer to which an electronic percussion instrument is connected and which has a display portion to execute a display processing, the display program causing the computer to display a striking surface display that models a striking surface of the electronic percussion instrument and is composed of at least a two-dimensional image, and display a strike position display disposed at at least a two-dimensional position based on a strike position acquired from the electronic percussion instrument at a corresponding position on the striking surface display.

### BRIEF DESCRIPTION OF THE DRAWINGS

FIG. 1 is a diagram representing an appearance of a sound source device.

FIG. 2A is a diagram representing the LCD in the case of a striking surface display for electronic drum being displayed, FIG. 2B is a diagram representing the striking surface display in the case of the striking surface center of the electronic drum being struck, FIG. 2C is a diagram representing the striking surface display in the case of the rim of the electronic drum being struck, and FIG. 2D and FIG. 2E are diagrams representing the striking surface display in the case of the electronic drum being open rim shot, respectively.

FIG. 3A is a diagram representing the LCD in the case of a striking surface display for electronic cymbal being displayed, FIG. 3B is a diagram representing the striking surface display for the case of the bell of the electronic cymbal being struck, FIG. 3C is a diagram representing the striking surface display in the case of the periphery portion of the electronic cymbal being choked, FIG. 3D is a diagram describing a method for detecting a strike position in an electronic drum, and FIG. 3E is a diagram describing a method for detecting a strike position in an electronic cymbal.

FIG. 4A is a diagram representing the LCD in the case of a striking surface display for analog pad being displayed, FIG. 4B is a diagram representing the striking surface display in the case of the striking surface center of the analog pad being struck, FIG. 4C is a diagram representing the striking surface display in the case of the rim of the analog pad being struck, and FIG. 4D and FIG. 4E are diagrams representing the striking surface display in the case of the analog pad being open rim shot, respectively.

FIG. 5 is a functional block diagram of the sound source device.

FIG. 6A is a block diagram showing an electrical configuration of the sound source device, FIG. 6B is a diagram schematically showing a strike display table, and FIG. 6C is a diagram schematically showing an instrument information table.

FIG. 7 is a flowchart of strike processing.

FIG. 8A is a diagram representing the striking surface display in the case of the electronic drum being open rim shot in a modification example, FIG. 8B is a diagram representing the striking surface display in the case of the periphery portion of the electronic cymbal being choked in another modification example, and FIG. 8C is a diagram representing the case of simultaneously displaying on the LCD the striking surface displays corresponding to all electronic percussion instruments connected to the sound source device in yet another modification example.

### DESCRIPTION OF THE EMBODIMENTS

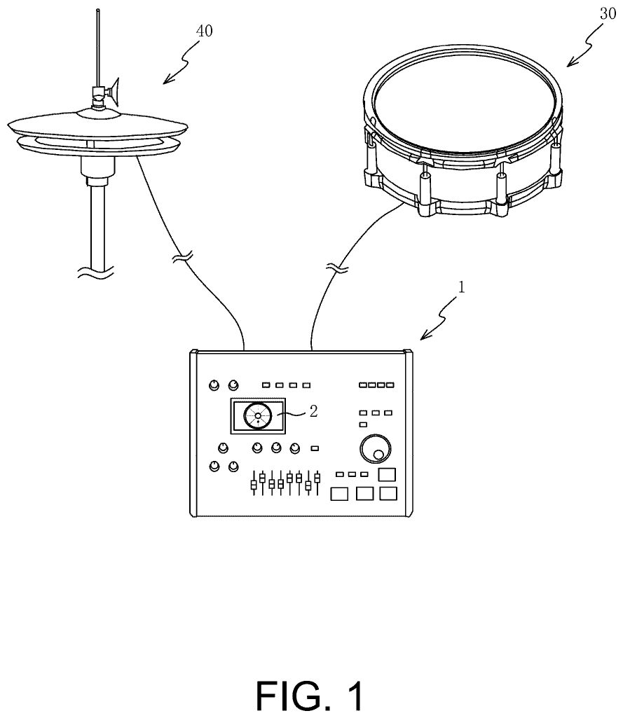

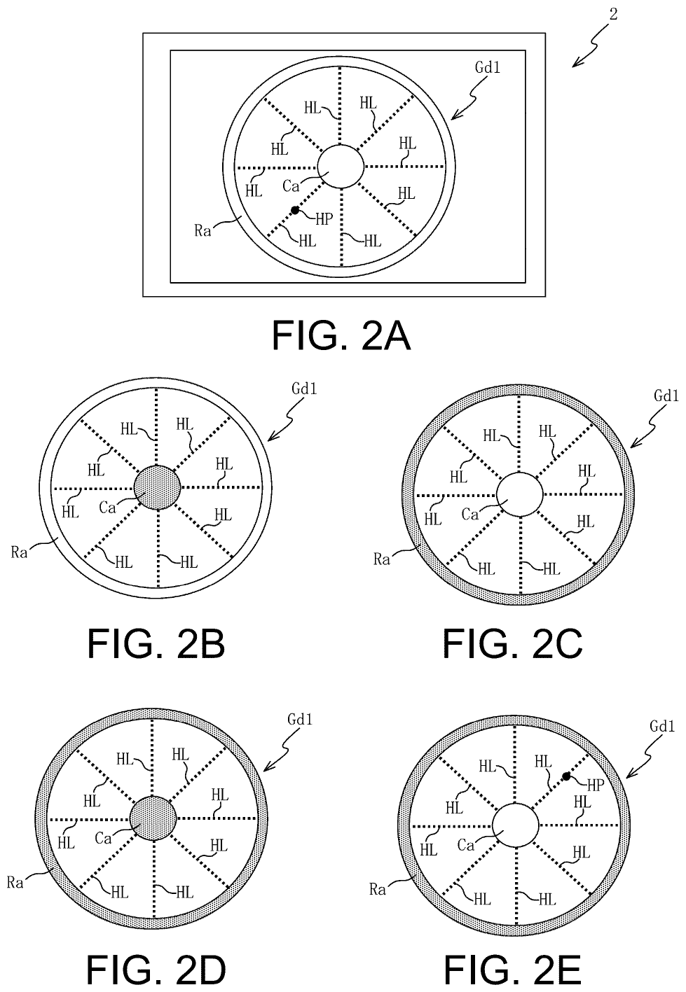

Hereinafter, embodiments will be described with reference to the accompanying drawings. With reference to FIG. 1, an overview of the sound source device 1 of this embodiment will be described. FIG. 1 is a diagram representing the appearance of the sound source device 1. The sound source device 1 is an electronic machine that outputs (emits) musical tones based on performance information received from electronic percussion instruments such as the electronic drum 30. The sound source device 1 is provided with an LCD 2 on which various setting values and a striking surface display Gd1, which will be described later from FIG. 2A to FIG. 2E onward, are displayed.

The electronic drum 30 and the electronic cymbal 40 are connected to the sound source device 1. The electronic drum 30 is an electronic percussion instrument that transmits performance information corresponding to strikes to the striking surface by the user H to the sound source device 1. The electronic drum 30 is provided with a circular striking surface in top view, and the performance information transmitted from the electronic drum 30 includes strike information of the striking surface (head) or rim, the strike position and velocity which is the position where the striking surface was struck, the position and pressure in the case of the striking surface being pressed, and the velocity in the case of the rim being struck, but information relating to strikes to the electronic drum 30 other than these may also be transmitted.

The electronic cymbal 40 is an electronic percussion instrument that transmits performance information corresponding to strikes to the striking surface by the user H to the sound source device 1. In this embodiment, an electronic hi-hat models a hi-hat is used as the electronic cymbal 40, but the disclosure is not limited thereto, and electronic cymbals models other cymbals such as ride cymbals may be used as the electronic cymbal 40.

The electronic cymbal 40 is also provided with a circular striking surface in top view, and the performance information transmitted from the electronic cymbal 40 includes strike information of the striking surface or bell, the strike position and velocity which is the position where the striking surface was struck, the pressing position in the case of choking where the periphery of the striking surface is picked and pressed by the user H, and the velocity in the case of the bell being struck, but information relating to strikes to the electronic cymbal 40 other than these may also be transmitted.

The electronic drum 30 and the electronic cymbal 40 in this embodiment are configured with so-called “digital pads” that may calculate performance information including strike position by themselves. As the detection method of strike position in the digital pad, a known method, for example, the method disclosed in Japanese Patent Application Laid-Open Publication No. 2018-36641, is used. Further, in this embodiment, the sound source device 1 and the electronic drum 30 and electronic cymbal 40 are connected by wire, but the disclosure is not limited thereto, and they may be connected wirelessly.

Performance information based on strikes to the electronic drum 30 and the like by the user H is transmitted to the sound source device 1, and the sound source device 1 generates and produces musical tones based on the performance information received from the electronic drum 30 and the like. At this time, particularly beginner users H whose performance skill is immature may want to understand where on the electronic drum 30 and the like was actually struck along with the production of musical tones.

Thus, in this embodiment, by displaying on the LCD 2 a striking surface display Gd1 and the like model the striking surface of the struck electronic drum 30 and the like, and a strike position display HP based on the strike position on the striking surface display Gd1 and the like, the user H may specifically understand the position where the electronic drum 30 and the like was struck. The striking surface display Gd1 and the like will be described with reference to FIG. 2A to FIG. 5.

FIG. 2A is a diagram representing the LCD 2 in the case of the striking surface display Gd1 for the electronic drum 30 being displayed. In the case of the electronic drum 30 being struck, the striking surface display Gd1 models the striking surface of the electronic drum 30 is displayed on the LCD 2. The striking surface display Gd1 is configured by an image that represents the striking surface of the electronic drum 30 in two dimensions (i.e., in a plane), and its outer shape is formed in a circular shape similar to the striking surface of the electronic drum 30.

The striking surface display Gd1 is provided with a central area display Ca, a rim area display Ra, and a radiation display HL. The central area display Ca is a circular display area displayed at the center in the striking surface display Gd1. In the electronic drum 30 of this embodiment, in the case of the striking surface center and a certain range around the striking surface center being struck, it is determined that the striking surface center was struck.

Thus, the central area display Ca is displayed in a region corresponding to the certain range where it is determined that the striking surface center was struck in the electronic drum 30 in the striking surface display Gd1. By such central area display Ca, the user H may understand the region where it is determined that the striking surface center was struck in the electronic drum 30.

In this embodiment, since the above-mentioned certain range in the electronic drum 30 is formed in a circular shape, the central area display Ca of the striking surface display Gd1 is also formed in a circular shape similarly, but the disclosure is not limited thereto. For example, in the case of the above-mentioned certain range being formed in a rectangular shape, the shape of the central area display Ca may be arbitrarily changed to match the shape of the above-mentioned certain range, such as forming the central area display Ca in a rectangular shape as well.

The rim area display Ra is a display area provided along the periphery of the striking surface display Gd1, and is formed based on the rim region in the electronic drum 30.

The radiation display HL is a linear display part formed radially from the central area display Ca toward the rim area display Ra. In this embodiment, eight radiation displays HL are provided in the striking surface display Gd1. In the case of a region in the electronic drum 30 excluding the striking surface center and the rim being struck, a strike position display HP based on the strike position is displayed on the striking surface display Gd1, and the strike position display HP is displayed on the radiation display HL closest to the received strike position.

The number of radiation displays HL is not limited to eight. For example, in the case of the detection accuracy of the strike position of the electronic drum 30 being high, the number of radiation displays HL may be more than eight, and in the case of the detection accuracy of the strike position of the electronic drum 30 being low, the number of radiation displays HL may be less than eight.

Further, as shown in FIG. 2A, the radiation displays HL are not limited to being arranged uniformly in the striking surface display Gd1. For example, in the case of positions with high strike detection accuracy and positions with low strike detection accuracy being mixed on the striking surface of the electronic drum 30, the density of radiation displays HL (that is, the number of radiation displays HL per unit area) may be increased in the region of the striking surface display Gd1 corresponding to positions with high strike detection accuracy, and the density of radiation displays HL may be decreased in the region of the striking surface display Gd1 corresponding to positions with low strike detection accuracy.

Here, the strike position display HP displayed on the radiation display HL will be described. The strike position display HP is a black circular display part that is displayed at a corresponding position in the striking surface display Gd1 in the case of a region in the electronic drum 30 excluding the striking surface center and the rim being struck. Since the striking surface display Gd1 is composed of an image that represents the striking surface of the electronic drum 30 in two dimensions, the strike position display HP is also disposed at a two-dimensional position (position on a plane) on the striking surface display Gd1.

In this way, the striking surface display Gd1 composed of a two-dimensional image modeling the striking surface of the electronic drum 30 is displayed, and the strike position display HP disposed at a two-dimensional position based on the strike position received from the electronic drum 30 is displayed on the striking surface display Gd1. That is, by displaying the striking surface display Gd1 modeling the striking surface of the electronic drum 30 represented on a plane and the strike position display HP disposed at a two-dimensional position on the striking surface display Gd1, the user H may more specifically grasp the position where the electronic drum 30 was struck.

Further, eight radiation displays HL are displayed in the striking surface display Gd1, and the strike position display HP is displayed on the radiation display HL closest to the strike position received from the electronic drum 30 among the eight radiation displays HL. That is, since the display of the strike position display HP is limited to the eight radiation displays HL from the entire striking surface display Gd1, the processing load of the sound source device 1 related to the display of the strike position display HP is reduced, and the strike position display HP may be displayed quickly.

Next, with reference to FIG. 2B to FIG. 2E, the striking surface display Gd1 in the case of each part of the electronic drum 30 being struck will be described. FIG. 2B is a diagram representing the striking surface display Gd1 in the case of the striking surface center of the electronic drum 30 being struck, FIG. 2C is a diagram representing the striking surface display Gd1 in the case of the rim of the electronic drum 30 being struck, and FIG. 2D and FIG. 2E are diagrams representing the striking surface display Gd1 in the case of the electronic drum 30 being open rim shot, respectively.

As shown in FIG. 2B, in the case of the striking surface center of the electronic drum 30 or a certain range around the striking surface center of the electronic drum 30 described above being struck, the display mode (e.g., color) of the central area display Ca in the striking surface display Gd1 is changed. In the figure, in the case of the striking surface center of the electronic drum 30 or the certain range described above not being struck, the central area display Ca is displayed in white as shown in FIG. 2A, and in the case of the striking surface center of the electronic drum 30 or the certain range described above being struck, the central area display Ca is displayed with hatching as shown in FIG. 2B.

In this way, since whether the striking surface center of the electronic drum 30 or the certain range described above has been struck is represented by the change in the display mode of the central area display Ca in the striking surface display Gd1, the change in the display mode of the central area display Ca may be said to be a “strike position display”. By comparing the user H's own strike near the striking surface center of the electronic drum 30 with the accompanying change in the display mode of the central area display Ca, the user H may more specifically grasp where the striking surface center or the certain range described above is, which is determined as the striking surface center surface being struck in the electronic drum 30.

The change in the display mode of the central area display Ca is not limited to the above, and may be other changes in display mode, such as displaying the central area display Ca in black in the case of the striking surface center of the electronic drum 30 or the certain range described above not being struck, and displaying the central area display Ca in yellow in the case of the striking surface center of the electronic drum 30 or the certain range described above being struck.

Next, with reference to FIG. 2C, the striking surface display Gd1 in the case of the rim of the electronic drum 30 being struck will be described. As shown in FIG. 2C, in the case of the rim of the electronic drum 30 being struck, the display mode (e.g., color) of the rim area display Ra in the striking surface display Gd1 is changed. In the drawing, in the case of the rim of the electronic drum 30 not being struck, the rim area display Ra is displayed in white as shown in FIG. 2A, and in the case of the rim of the electronic drum 30 being struck, the rim area display Ra is displayed with hatching as shown in FIG. 2C.

In this way, in the case of the rim of the electronic drum 30 being struck, by the display mode of the rim area display Ra changing, the user H may easily grasp that the rim of the electronic drum 30 has been struck. The change in the display mode of the rim area display Ra is also not limited to the above, and may be other changes in display mode, such as displaying the rim area display Ra in light blue in the case of the rim of the electronic drum 30 not being struck, and displaying the rim area display Ra in red in the case of the rim of the electronic drum 30 being struck.

Next, with reference to FIG. 2D and FIG. 2E, the striking surface display Gd1 in the case of the electronic drum 30 being open rim shot will be described. As shown in FIG. 2D, in the case of an open rim shot in which the striking surface center of the electronic drum 30 or the certain range described above and the rim are struck simultaneously, the display modes of the central area display Ca and the rim area display Ra are changed simultaneously. Further, as shown in FIG. 2E, in the case of an open rim shot in which a position on the periphery side from the striking surface center of the electronic drum 30 or the certain range described above and the rim are struck simultaneously, the strike position display HP is displayed at a position in the striking surface display Gd1 corresponding to that periphery side position, and the display mode of the rim area display Ra is changed.

In this way, in the case of the electronic drum 30 being open rim shot, by the change in the display mode of the rim area display Ra together with displaying the strike position display HP corresponding to the position where the electronic drum 30 was struck or the change in the display mode of the central area display Ca, the user H may easily grasp that the electronic drum 30 has been open rim shot and where on the striking surface was struck together with the rim by the open rim shot.

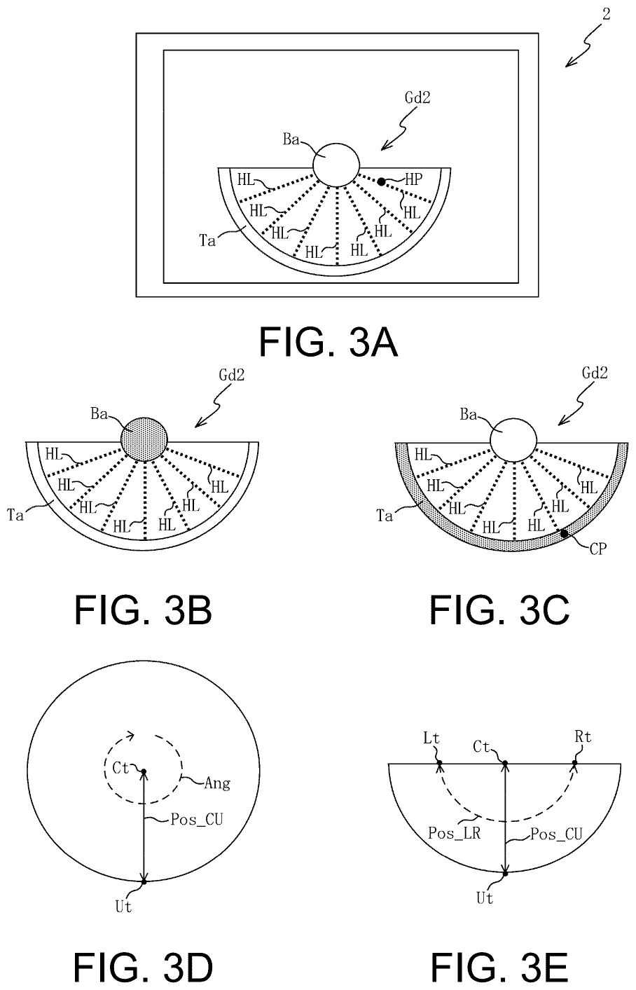

Next, with reference to FIG. 3A to FIG. 3C, the striking surface display Gd2 for the electronic cymbal 40 will be described. FIG. 3A is a diagram representing the LCD 2 in the case of the striking surface display Gd2 for the electronic cymbal 40 being displayed. In the case of the electronic cymbal 40 being struck, the striking surface display Gd2 modeling the striking surface of the electronic cymbal 40 is displayed on the LCD 2. The striking surface display Gd2 is configured by an image that represents the striking surface of the electronic cymbal 40 in two dimensions. The outer shape of the striking surface display Gd2 is formed in a semicircular shape by the lower half in the top view of the striking surface of the electronic cymbal 40.

The striking surface display Gd2 is provided with a bell display Ba, a periphery display Ta provided along the periphery of the striking surface display Gd2, and radiation displays HL. The bell display Ba is a circular display area displayed at the center in the striking surface display Gd2. The bell display Ba is formed in a circular shape according to the bell of the electronic cymbal 40.

The radiation display HL is a linear display part formed radially from the bell display Ba toward the periphery display Ta. In this embodiment, seven radiation displays HL are provided in the striking surface display Gd2. The number of radiation displays HL in the striking surface display Gd2 may also be seven or more or seven or less according to the detection accuracy of the strike position of the electronic cymbal 40, etc.

In the case of a region in the electronic cymbal 40 excluding the bell and the periphery portion being struck, similar to the striking surface display Gd1 described above in FIG. 2A to FIG. 2E, the strike position display HP is displayed on the radiation display HL closest to the received strike position. The strike position display HP in the striking surface display Gd2 is also disposed at a two-dimensional position (coordinates) on the striking surface display Gd2.

In this way, the striking surface display Gd2 configured by a two-dimensional image modeling the striking surface of the electronic cymbal 40 is displayed, and the strike position display HP disposed at a two-dimensional position based on the strike position received from the electronic cymbal 40 is displayed on the striking surface display Gd2. Accordingly, similar to the striking surface display Gd1 for the electronic drum 30 described above, the user H may more specifically grasp the position where the electronic cymbal 40 was struck.

Incidentally, while the outer shape of the striking surface display Gd1 corresponding to the electronic drum 30 is formed in a circular shape similar to the shape in the top view of the striking surface of the electronic drum 30, and the outer shape of the striking surface display Gd2 corresponding to the electronic cymbal 40 is formed in a semicircular shape by the lower half of the shape (circular shape) in the top view of the striking surface.

This is because while strike detection is possible on the entire striking surface of the electronic drum 30, the electronic cymbal 40 may detect strikes only in the lower half region in the top view of the striking surface. In this way, by the striking surface display Gd2 being formed in a shape corresponding to the position where strike detection is possible on the striking surface of the electronic cymbal 40, the user H may easily grasp the region where strike detection is possible on the striking surface of the electronic cymbal 40.

Next, with reference to FIG. 3B and FIG. 3C, the striking surface display Gd2 in the case of the bell of the electronic cymbal 40 being struck and in the case of the periphery portion of the electronic cymbal 40 being choked will be described. FIG. 3B is a diagram representing the striking surface display Gd2 in the case of the bell of the electronic cymbal 40 being struck, and FIG. 3C is a diagram representing the striking surface display Gd2 in the case of the periphery portion of the electronic cymbal 40 being choked.

As shown in FIG. 3B, in the case of the bell of the electronic cymbal 40 being struck, the display mode (e.g., color) of the bell display Ba is changed. In the figure, in the case of the bell of the electronic cymbal 40 not being struck, the bell display Ba is displayed in white as shown in FIG. 3A, and in the case of the bell of the electronic cymbal 40 being struck, the bell display Ba is displayed with hatching as shown in FIG. 3B.

In this way, in the case of the bell of the electronic cymbal 40 being struck, by the display mode of the bell display Ba changing, the user H may easily grasp that the bell of the electronic cymbal 40 has been struck. The change in the display mode of the bell display Ba is not limited to the above, and for example, in the case of the bell of the electronic cymbal 40 not being struck, the bell display Ba may be displayed in green, and in the case of the bell of the electronic cymbal 40 being struck, the bell display Ba may be displayed in red, or other changes in display mode may be used.

Further, as shown in FIG. 3C, in the case of choke being performed in which the periphery portion of the electronic cymbal 40 is pinched by the user H, the display mode of the periphery display Ta of the striking surface display Gd2 is changed, and at a position corresponding to the pressing position where the electronic cymbal 40 is pressed by the choke in the periphery display Ta, a choke display CP, which is a black circular display part, is displayed. Thereby, the user H may easily grasp that the periphery portion of the electronic cymbal 40 has been choked and where on the periphery portion has been pinched.

In this way, in the case of the electronic drum 30 being struck, the striking surface display Gd1 of FIG. 2A to FIG. 2E is displayed on the LCD 2, and in the case of the electronic cymbal 40 being struck, the striking surface display Gd2 of FIG. 3A to FIG. 3C is displayed on the LCD 2. In this embodiment, the striking surface display Gd1 or the striking surface display Gd2 displayed on the LCD 2 is switched based on “position type” assigned to each of the struck electronic drum 30 and the electronic cymbal 40. The position type will be described with reference to FIG. 3D and FIG. 3E.

FIG. 3D is a diagram describing a method for detecting the strike position of the electronic drum 30, and FIG. 3E is a diagram describing a method for detecting the strike position of the electronic cymbal 40. The electronic drum 30 and the electronic cymbal 40 in this embodiment are configured as so-called “digital pads” capable of acquiring performance information including strike position by themselves, and the methods for detecting strike position differ in each.

In the electronic drum 30, as shown in FIG. 3D, the strike position is detected by a combination of a position Pos_CU on a center-periphery axis connecting from the center Ct to the periphery Ut, and an angle Ang centered on the center Ct.

On the other hand, in the electronic cymbal 40, as shown in FIG. 3E, the strike position is detected by a combination of a position Pos_CU on a center-periphery axis connecting from the center Ct to the periphery Ut, and a position Pos_LR on a left-right axis connecting the upper end Rt of the right half of the striking surface and the upper end Lt of the left half of the striking surface.

Hereinafter, such a method for detecting strike position in electronic percussion instruments is referred to as “position type”. In this embodiment, display parts such as corresponding striking surface displays Gd1 and Gd2 are assigned per position type. Specifically, to position type: “center-periphery axis” and “angle” (FIG. 3D), display parts used together with the striking surface display Gd1 such as the striking surface display Gd1 and the central area display Ca (FIG. 2A) are assigned, and to position type: “center-periphery axis” and “left-right axis”, the striking surface display Gd2 and display parts used together with the striking surface display Gd2 (FIG. 3A) are assigned.

Furthermore, position type is assigned by the user H to each electronic percussion instrument connected to the sound source device 1. For example, position type: “center-periphery axis” and “angle” is assigned to the electronic drum 30, and position type: “center-periphery axis”and “left-right axis”is assigned to the electronic cymbal 40.

Then, among the electronic percussion instruments connected to the sound source device 1, the position type of the struck electronic percussion instrument is acquired, display parts such as striking surface displays Gd1 and Gd2 corresponding to the acquired position type are acquired, and displayed on the LCD 2. Accordingly, in the case of the electronic drum 30 being struck, the striking surface display Gd1 as shown in FIG. 2A is displayed on the LCD 2 of the sound source device 1, and in the case of the electronic cymbal 40 being struck, the striking surface display Gd2 as shown in FIG. 3A is displayed on the LCD 2 of the sound source device 1.

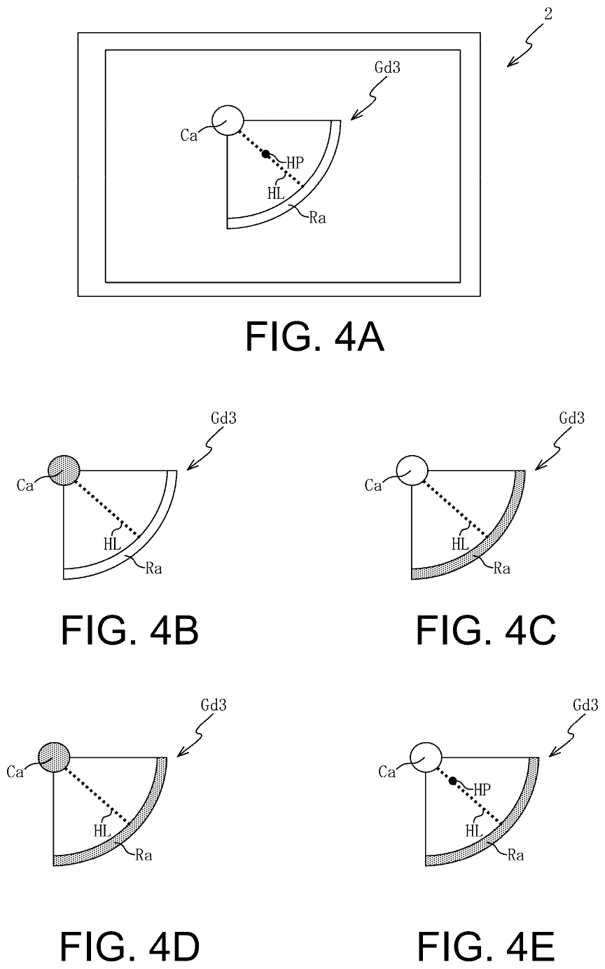

Incidentally, the sound source device 1 is configured to be connectable not only to digital pads such as the electronic drum 30 and electronic cymbal 40, but also to analog pads that transmit only strike waveforms which are waveforms based on output values of sensors that detect strikes, and musical tones based on the received strike waveforms are generated. Since the strike position that may be acquired from strike waveforms received from analog pads is only the “center-periphery axis” shown above, the position type of analog pads is “center-periphery axis”. Here, with reference to FIG. 4A to FIG. 4E, a striking surface display Gd3 displayed on the LCD 2 in the case of an analog pad being struck will be described.

FIG. 4A is a diagram representing the LCD 2 in the case of the striking surface display Gd3 for analog pad being displayed. In the case of the analog pad being struck, the striking surface display Gd3 is displayed on the LCD 2. The striking surface display Gd3 is provided with the central area display Ca, the rim area display Ra, and the radiation display HL similar to the striking surface display Gd1 described above in FIG. 2A to FIG. 2E.

Among these, the radiation display HL differs from the striking surface displays Gd1 and Gd2 described above in FIG. 2A to FIG. 2E and FIG. 3A to FIG. 3E, and only one is displayed. This is because the position type of analog pads is “center-periphery axis” and may only detect strike positions in a uniaxial direction. In the case of a region on the analog pad excluding the striking surface center and rim being struck, the strike position display HP based on that strike position is displayed on the radiation display HL.

Next, with reference to FIG. 4B to FIG. 4E, the striking surface display Gd3 in the case of each part of the analog pad being struck will be described. FIG. 4B is a diagram representing the striking surface display Gd3 in the case of the striking surface center of the analog pad being struck, FIG. 4C is a diagram representing the striking surface display Gd3 in the case of the rim of the analog pad being struck, and FIG. 4D and FIG. 4E are diagrams representing the striking surface display Gd3 in the case of the analog pad being open rim shot, respectively.

As shown in FIG. 4B, in the case of the striking surface center of the analog pad or the certain range around it being struck, the display mode (e.g., color) of the central area display Ca is changed, and as shown in FIG. 4C, in the case of the rim of the analog pad being struck, the display mode of the rim area display Ra is changed. Further, as shown in FIG. 4D and FIG. 4E, in the case of the analog pad being open rim shot, along with the change in display mode of the rim area display Ra, the strike position display HP displayed corresponding to the position where the electronic drum 30 was struck or the display mode of the central area display Ca is changed.

In this way, even in the striking surface display Gd3 for analog pad, display equivalent to the striking surface display Gd1 for electronic drum 30 and the striking surface display Gd2 for electronic cymbal 40 is provided. Accordingly, by connecting the analog pad and the electronic drum 30 to the sound source device 1, it is possible to suppress the user H from feeling discomfort between the display content displayed on the LCD 2 in the case of striking the analog pad and the display content displayed on the LCD 2 in the case of striking the electronic drum 30.

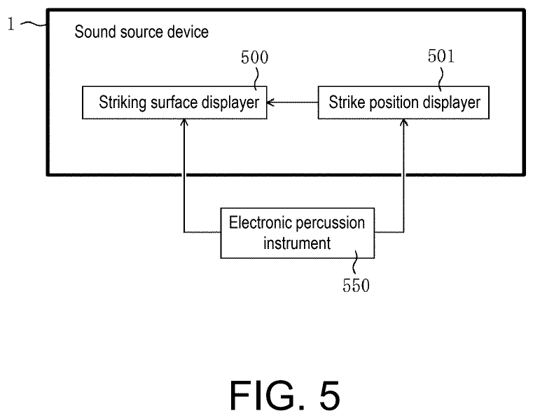

Next, with reference to FIG. 5, the functions of the sound source device 1 will be described. FIG. 5 is a functional block diagram of the sound source device 1. As shown in FIG. 5, the sound source device 1 includes a striking surface displayer 500 and a strike position displayer 501.

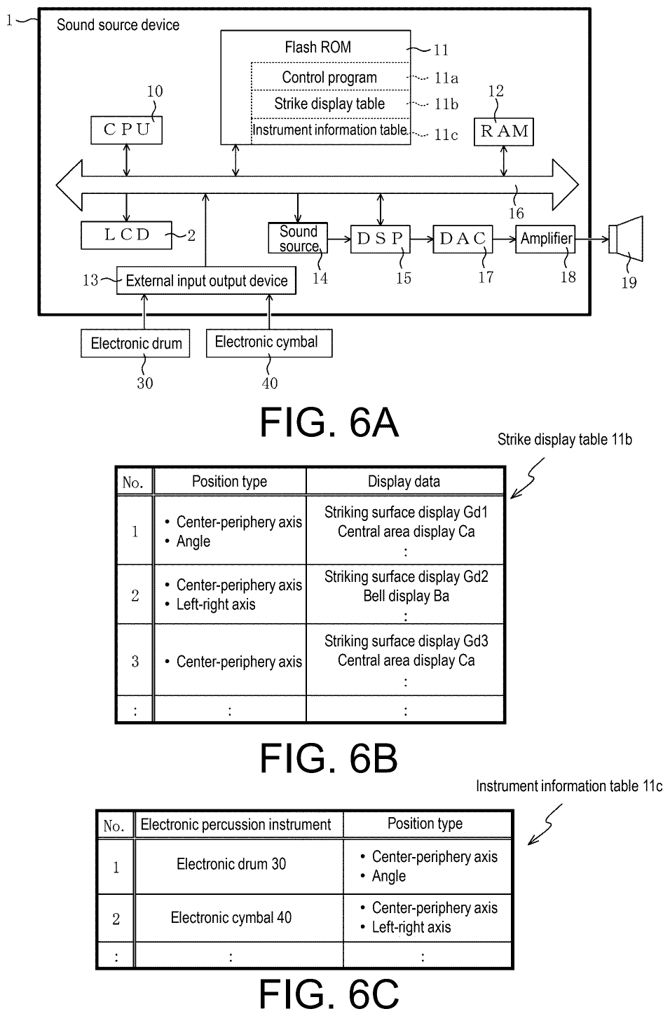

The striking surface displayer 500 is a displayer for displaying the striking surface displays Gd1 and Gd2 configured by at least two-dimensional images that model the striking surfaces of electronic percussion instruments 550 such as the electronic drum 30 and the electronic cymbal 40, and is implemented by a CPU 10 described later in FIG. 6A. The strike position displayer 501 is a displayer for displaying the strike position display HP disposed at at least two-dimensional positions based on strike positions acquired from the electronic percussion instrument 550 on the striking surface displays Gd1 and Gd2 displayed by the striking surface displayer 500, and is implemented by the CPU 10.

That is, the striking surface displays Gd1 and Gd2 configured by two-dimensional images that model electronic percussion instrument 550 are displayed, and the strike position display HP disposed at two-dimensional positions based on strike positions acquired from the electronic percussion instrument 550 is displayed at corresponding positions on the striking surface displays Gd1 and Gd2. By displaying the striking surface displays Gd1 and Gd2 configured by at least two-dimensional images, for example, the striking surface displays Gd1 and Gd2 expressed in a plane, and the strike position display HP disposed at at least two-dimensional positions on the striking surface displays Gd1 and Gd2, the user H may more specifically grasp the position where the electronic percussion instrument 550 was struck.

Next, with reference to FIG. 6A to FIG. 6C, the electrical configuration of the sound source device 1 will be described. FIG. 6A is a block diagram showing the electrical configuration of the sound source device 1. The sound source device 1 includes a CPU 10, a flash ROM 11, a RAM 12, the above-described LCD 2, an external input output device 13, a sound source 14, and a DSP (digital signal processor) 15, each connected via a bus line 16. A DAC (digital analog converter) 17 is connected to the DSP 15, an amplifier 18 is connected to the DAC 17, and a speaker 19 is connected to the amplifier 18.

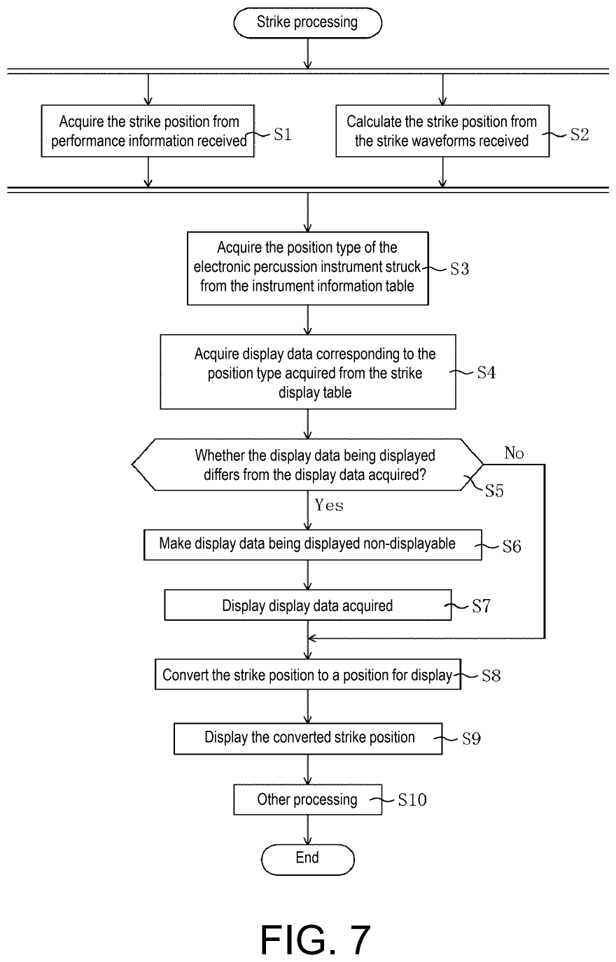

The CPU 10 is a computing device that controls each part connected by the bus line 16. The flash ROM 11 is a rewritable non-volatile memory, and includes a control program 11a, a strike display table 11b, and an instrument information table 11c. In response to the control program 11a being executed by the CPU 10, main processing of FIG. 7 is executed. The strike display table 11b and the instrument information table 11c will be described with reference to FIG. 6B and FIG. 6C.

FIG. 6B is a diagram schematically showing the strike display table 11b. The strike display table 11b stores display data which is data related to display of the striking surface display Gd1 and the like displayed for each of the above-described position types. For example, position type: “center-periphery axis” and “angle” (that is, in the case of electronic drum 30) are stored in association with the striking surface display Gd1, the central area display Ca, and the rim area display Ra as display data.

Position type: “center-periphery axis” and “left-right axis” (that is, in the case of electronic cymbal 40) are stored in association with the striking surface display Gd2, the bell display Ba, and the periphery display Ta as display data. Further, position type: “center-periphery axis” (that is, in the case of analog pad) are stored in association with the striking surface display Gd3, the central area display Ca, and the rim area display Ra.

FIG. 6C is a diagram schematically showing the instrument information table 11c. The instrument information table 11c stores position types for each electronic percussion instrument connected to the sound source device 1. For example, position type: “center-periphery axis” and “angle” are stored for the electronic drum 30, and position type: “center-periphery axis” and “left-right axis” are stored for the electronic cymbal 40. The instrument information table 11c stores combinations of electronic percussion instruments and position types input from the user H via an input device (not shown) provided in the sound source device 1.

Among the electronic percussion instruments connected to the sound source device 1, the position type of the struck electronic percussion instrument is acquired from the instrument information table 11c, display data corresponding to that position type is acquired from the strike display table 11b, and the striking surface display Gd1 and the like are displayed on the LCD 2 using the acquired display data.

Returning to FIG. 6A. The RAM 12 is a memory that stores various work data and flags in a rewritable manner in response to the CPU 10 executing programs such as control program 11a. The external input output device 13 is a device that inputs and outputs information from connected external machines. Electronic percussion instruments such as the electronic drum 30 and the electronic cymbal 40 are connected to the external input output device 13, and performance information from electronic percussion instruments of digital pad and strike waveforms from electronic percussion instruments of analog pad are received.

In this embodiment, USB (registered trademark) is used as the communication standard of the external input output device 13, but the external input output device 13 may be configured with other communication standards, or may be configured to input and output information from external machines by wireless communication.

The sound source 14 is a device that outputs waveform data according to performance information input from the CPU 10. The DSP 15 is a computing device for performing arithmetic processing on waveform data input from the sound source 14. The DAC 17 is a conversion device that converts waveform data input from the DSP 15 into analog waveform data. The amplifier 18 is an amplification device that amplifies analog waveform data output from the DAC 17 with a predetermined gain. The speaker 19 is an output device that emits (outputs) analog waveform data amplified by the amplifier 18 as musical tones.

Next, with reference to FIG. 7, processing executed by the CPU 10 of the sound source device 1 will be described. FIG. 7 is a flowchart of strike processing. Strike processing is event processing executed in response to receiving performance information or strike waveform from an electronic percussion instrument via the external input output device 13 after power-on of the sound source device 1.

Strike processing first acquires the strike position from performance information received from digital pads such as the electronic drum 30 and the electronic cymbal 40 among the electronic percussion instruments (S1). Further, the strike position is calculated from the strike waveforms received from the analog pads among the electronic percussion instruments (S2). For the calculation method of the strike position from the strike waveform in the processing of S2, a known method, for example, the method disclosed in Japanese Patent Application Laid-Open Publication No. 2021-105702, is used. In this embodiment, the processing of S1 and the processing of S2 are executed in parallel.

After the processing of S1 and S2, the position type corresponding to the electronic percussion instrument for which the strike position was acquired or calculated in the processing of S1 and S2 is acquired from the instrument information table 11c (see FIG. 6C) (S3). Specifically, among the electronic percussion instruments connected to the external input output device 13, the electronic percussion instrument for which the strike position was acquired or calculated in the processing of S1 and S2 is identified, and the position type corresponding to the identified electronic percussion instrument is acquired from the instrument information table 11c.

After the processing of S3, display data corresponding to the position type acquired in the processing of S3 is acquired from the strike display table 11b (see FIG. 6B) (S4), and it is confirmed whether the display data being displayed on the LCD 2 differs from the display data acquired in the processing of S4 (S5).

In the processing of S5, in the case of confirming that the display data being displayed differs from the display data acquired in the processing of S4 (S5: Yes), the display data being displayed is made non-displayable on the LCD 2 (S6). After the processing of S6, the display data acquired in the processing of S4 is displayed on the LCD 2 (S7). As a result, the striking surface display Gd1 and the like corresponding to the electronic percussion instrument struck previously are made non-displayable, and the striking surface display Gd1 and the like corresponding to the electronic percussion instrument struck this time are newly displayed. On the other hand, in the processing of S5, in the case of confirming that the display data being displayed is identical to the display data acquired in the processing of S4 (S5: No), the processing of S6 and S7 is skipped.

After the processing of S5 and S7, the strike position acquired or calculated in the processing of S1 and S2 is converted to a position for display (S8). Specifically, the strike position is converted so that the strike position acquired or calculated in the processing of S1 and S2 is placed at a corresponding position on the striking surface display Gd1 and the like. At this time, the strike position is moved so that the strike position is on the closest radiation display HL among the radiation displays HL of the striking surface display Gd1 and the like.

Furthermore, among the strike positions acquired or calculated in the processing of S1 and S2, the position of the center-periphery axis is expressed in 128 stages from 0 to 127, so such strike position is converted to 8 stages from 0 to 7. As a result, the positions where the strike position display HP is displayed on the radiation display HL are reduced from 128 to 8, so the processing load of the sound source device 1 for displaying the strike position display HP is reduced, and the strike position display HP may be displayed quickly.

After the processing of S8, based on the strike position converted in the processing of S8, the strike position display HP is displayed, the display modes of the central area display Ca and the rim area display Ra in the striking surface displays Gd1 and Gd3 are changed, and the display modes of the bell display Ba and the periphery display Ta in the striking surface display Gd2 are changed (S9).

After the processing of S9, other processing of the sound source device 1 is executed (S10). The other processing in S10 includes processing for generating musical tones based on the received performance information or strike waveform and outputting the generated musical tones. After the processing of S10, the strike processing ends.

As described above based on the above embodiment, it may be easily inferred that various improvements and modifications are possible.

In the above embodiment, in FIG. 2B to FIG. 2E, the striking surface display Gd1 in the case of the rim of the electronic drum 30 being struck or the electronic drum 30 being open rim shot is represented, but in addition to these, display in the case of the electronic drum 30 being closed rim shot may be performed on the striking surface display Gd1.

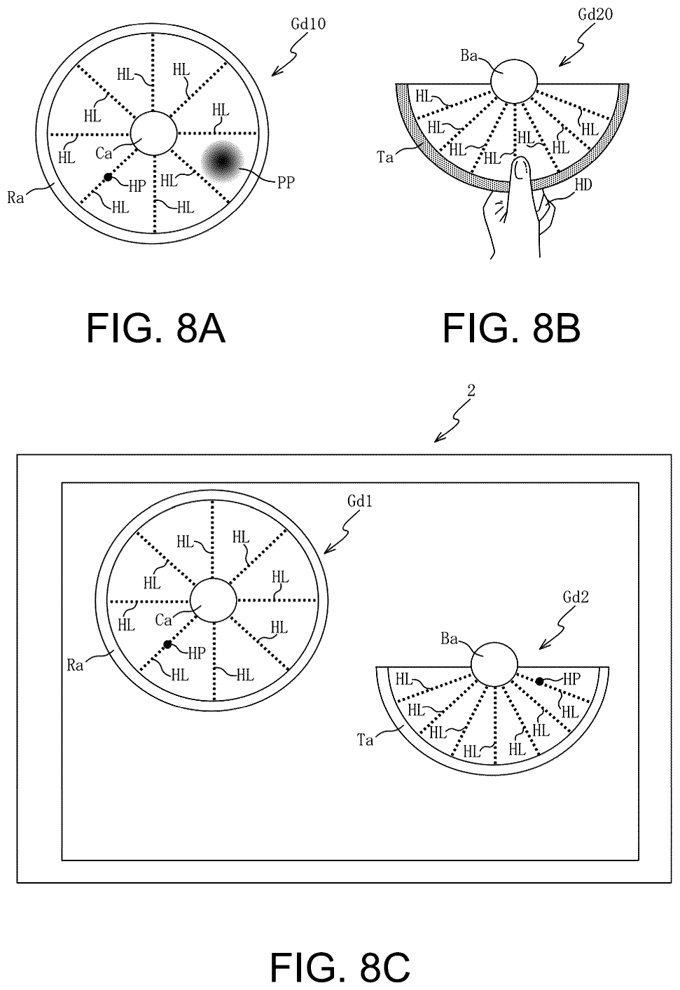

In this case, as represented in the striking surface display Gd10 of FIG. 8A, along with the strike position display HP, the press display PP may be performed at a position corresponding to the position where the striking surface of the electronic drum 30 was pressed by the closed rim shot in the striking surface display Gd10. With such striking surface display Gd10, the user H may easily grasp that the electronic drum 30 was closed rim shot, and where on the striking surface was struck and further pressed at that time.

In the above embodiment, in the striking surface display Gd2 of FIG. 3C, the choke display CP is displayed in a black circular shape, but it is not limited thereto. For example, instead of the choke display CP, as represented in the striking surface display Gd20 of FIG. 8B, the choke display HD models a human hand may be displayed. As a result, the user H may more intuitively grasp that the electronic cymbal 40 was choked.

In the above embodiment, the striking surface displays Gd1 to Gd3 displayed on the LCD 2 are only those corresponding to the electronic percussion instruments that are actually struck, but it is not limited thereto, and the striking surface displays Gd1 to Gd3 corresponding to all electronic percussion instruments connected to the sound source device 1 may be displayed simultaneously. For example, as shown in FIG. 8C, in the case of the electronic drum 30 and the electronic cymbal 40 being connected to the sound source device 1, the striking surface display Gd1 and the striking surface display Gd2 may be displayed simultaneously on the LCD 2. As a result, the user H may grasp at a glance what electronic percussion instruments are connected to the sound source device 1.

Further, regardless of whether or not the electronic percussion instrument connected to the sound source device 1 is struck, predetermined striking surface displays Gd1 to Gd3 may always be displayed on the LCD 2. In this case, the striking surface displays Gd1 to Gd3 designated in advance by the user H may always be displayed on the LCD 2.

In the above embodiment, the striking surface display Gd2 of FIG. 3A to FIG. 3C is formed in a semicircular shape to match the region where strikes may be detected in the electronic cymbal 40, but it is not limited thereto. The striking surface display Gd2 may be formed in a circular shape similar to the shape of the striking surface of the electronic cymbal 40 in top view. At this time, in the circular striking surface display Gd2, it is preferable to make the display modes (e.g., color) different between the region where strikes may be detected by the electronic cymbal 40 and the region where strike detection is not possible.

In the above embodiment, the striking surface displays Gd1 to Gd3 displayed on the LCD 2 are switched based on the position type of the struck electronic percussion instrument, but it is not limited thereto. For example, the striking surface displays Gd1 to Gd3 displayed on the LCD 2 may be switched based on other information that identifies the electronic percussion instrument, such as model information of the struck electronic percussion instrument.

In the above embodiment, the striking surface displays Gd1 to Gd3 are two-dimensional (planar) images, but it is not limited thereto. For example, the striking surface displays Gd1 to Gd3 may be three-dimensional (solid) images. Further, the strike position display HP is disposed at a two-dimensional position, but it is not limited thereto, and may be disposed at a three-dimensional position.

In the above embodiment, linear radiation displays HL are displayed on the striking surface displays Gd1 to Gd3, but it is not limited thereto. The radiation displays HL may be other shapes such as polygonal lines or curved lines. Further, the radiation displays HL may be omitted from the striking surface displays Gd1 to Gd3.

In the above embodiment, the electronic drum 30 and the electronic cymbal 40 are used as electronic percussion instruments, but it is not limited thereto, and other electronic percussion instruments such as an electronic conga may be used.

In the above embodiment, the control program 11a was stored in the flash ROM 11 of the sound source device 1 and configured to operate on the sound source device 1. However, it is not necessarily limited thereto, and the control program 11a may be configured to operate on other computers such as PC (personal computer), mobile phone, smartphone, tablet terminal, or other electronic machines. In this case, a device similar to the external input output device 13 may be provided in the PC, mobile phone, etc., and configured to be connectable with the electronic percussion instruments such as the electronic drum 30.

What is claimed is:

1. An electronic machine to which an electronic percussion instrument is connected, the electronic machine comprising:
a processor configured to:
display a striking surface display that models a striking surface of the electronic percussion instrument and is composed of at least a two-dimensional image; and
display a strike position display disposed at at least a two-dimensional position based on a strike position acquired from the electronic percussion instrument at a corresponding position on the striking surface display.

2. The electronic machine according to claim 1, wherein a plurality of electronic percussion instruments are connected to the electronic machine,
the processor displays a striking surface display that models a striking surface of the electronic percussion instrument that is struck among the plurality of electronic percussion instruments, and
displays the strike position display based on a strike position from the electronic percussion instrument that is struck among the plurality of electronic percussion instruments at a corresponding position on the striking surface display.

3. The electronic machine according to claim 1, wherein the processor displays a position where a strike is detectable on a striking surface of the electronic percussion instrument as the striking surface display.

4. The electronic machine according to claim 1, wherein
the processor displays a plurality of radiation displays from a striking surface center toward a periphery in the striking surface display, and
displays the strike position display on the radiation display that is closest to a strike position acquired from the electronic percussion instrument.

5. The electronic machine according to claim 1, wherein
the processor displays a central area display in the striking surface display at a striking surface center in the corresponding electronic percussion instrument and in a region around the striking surface center that is treated as a strike to the striking surface center when being struck, and
displays the strike position display in the central area display in a case of a strike position acquired from the electronic percussion instrument being a striking surface center.

6. The electronic machine according to claim 1, wherein
the processor displays a rim area display on a periphery of a striking surface in the striking surface display, and
displays a strike position display in the rim area display in a case of a strike position acquired from the electronic percussion instrument being a rim.

7. The electronic machine according to claim 6, wherein the processor, in a case of detecting that an open rim shot has been performed in the electronic percussion instrument, displays a strike position display corresponding to a strike to a striking surface at that time and a strike position display to the rim area display.

8. The electronic machine according to claim 6, wherein the processor, in a case of detecting that a closed rim shot has been performed in the electronic percussion instrument, displays a strike position display corresponding to a strike to a striking surface at that time and a press display representing a position where the striking surface is pressed in the closed rim shot.

9. The electronic machine according to claim 1, wherein the electronic percussion instrument is an electronic cymbal,
the processor displays a periphery display on a periphery of a striking surface in the striking surface display, and
the processor displays a choke display representing a position where the periphery is pressed on the periphery display in a case of detecting a choke in which the periphery is pressed in the electronic cymbal.

10. A display method, comprising:
displaying a striking surface display that models a striking surface of a connected electronic percussion instrument and is composed of at least a two-dimensional image, and
displaying a strike position display disposed at at least a two-dimensional position based on a strike position acquired from the electronic percussion instrument at a corresponding position on the striking surface display.

11. The display method according to claim 10, wherein a plurality of electronic percussion instruments are connected to the electronic machine, and the method comprises:
displaying a striking surface display that models a striking surface of the electronic percussion instrument that is struck among the plurality of electronic percussion instruments, and
displaying the strike position display based on a strike position from the electronic percussion instrument that is struck among the plurality of electronic percussion instruments at a corresponding position on the striking surface display.

12. The display method according to claim 10, wherein the method comprises:
displaying a position where a strike is detectable on a striking surface of the electronic percussion instrument as the striking surface display.

13. The display method according to claim 10, wherein the method comprises:
displaying a plurality of radiation displays from a striking surface center toward a periphery in the striking surface display, and
displaying the strike position display on the radiation display that is closest to a strike position acquired from the electronic percussion instrument.

14. The display method according to claim 10, wherein the method comprises:
displaying a central area display in the striking surface display at a striking surface center in the corresponding electronic percussion instrument and in a region around the striking surface center that is treated as a strike to the striking surface center when being struck, and
displaying the strike position display in the central area display in a case of a strike position acquired from the electronic percussion instrument being a striking surface center.

15. The display method according to claim 10, wherein the method comprises:
displaying a rim area display on a periphery of a striking surface in the striking surface display, and
displaying a strike position display in the rim area display in a case of a strike position acquired from the electronic percussion instrument being a rim.

16. The display method according to claim 15, wherein the method comprises:
in a case of detecting that an open rim shot has been performed in the electronic percussion instrument, displaying a strike position display corresponding to a strike to a striking surface at that time and a strike position display to the rim area display.

17. The display method according to claim 15, wherein the method comprises:
in a case of detecting that a closed rim shot has been performed in the electronic percussion instrument, displaying a strike position display corresponding to a strike to a striking surface at that time and a press display representing a position where the striking surface is pressed in the closed rim shot.

18. The display method according to claim 10, wherein the electronic percussion instrument is an electronic cymbal, and the method comprises:
displaying a periphery display on a periphery of a striking surface in the striking surface display, and
displaying a choke display representing a position where the periphery is pressed on the periphery display in a case of detecting a choke in which the periphery is pressed in the electronic cymbal.

19. A non-transitory computer-readable recording medium, recording a display program for causing a computer to which an electronic percussion instrument is connected and which has a display portion to execute a display processing, the display program causing the computer to:
display a striking surface display that models a striking surface of the electronic percussion instrument and is composed of at least a two-dimensional image, and
display a strike position display disposed at at least a two-dimensional position based on a strike position acquired from the electronic percussion instrument at a corresponding position on the striking surface.

20. The recording medium according to claim 19, wherein the electronic percussion instrument is an electronic cymbal, and the display program further causes the computer to:
display a periphery display on a periphery of a striking surface in the striking surface display, and
display a choke display representing a position where the periphery is pressed on the periphery display in a case of detecting a choke in which the periphery is pressed in the electronic cymbal.
